(19) United States
(12) Patent Application Publication
(10) Pub. No.: US 2026/0358637 A1
(43) Pub. Date: Nov. 12, 2026

(54) DISPLAY DEVICE

(71) Applicant: tooz technologies GmbH, Aalen (DE)

(72) Inventors: Michael POLLMANN, Koenigsbronn (DE); Hans-Juergen DOBSCHAL, Bad Sulza (DE); Georg MICHELS, Aalen (DE)

(21) Appl. No.: 19/470,062

(22) PCT Filed: Mar. 26, 2024
(86) PCT No.: PCT/EP2024/058068

§ 371 Date: Sep. 28, 2025

(30) Foreign Application Priority Data
Mar. 29, 2023 (DE) 10 2023 107 977.8

(51) Int. Cl. G02B 27/01

(52) U.S. Cl. CPC G02B 27/0172; G02B 2027/0178

(57) ABSTRACT

An image generating module has a first image generator for a first color sub-image, a second image generator for a second color sub-image, and a combiner comprising a first and a second entrance surface and an exit surface. The first color sub-image enters via the first entrance surface and is guided along a first color channel as far as a first reflection layer, which reflects one of the two color sub-images and transmits the other of the two color sub-images. The second color sub-image enters via the second entrance surface and is guided along a second color channel as far as the first reflection layer. The first entrance surface and/or in the first color channel a first hologram provides a first imaging function for the first color sub-image to correct an aberration caused by the spectacle lens.

### PRIORITY

This application claims the priority of German patent application DE 10 2023 107 977.8 filed Mar. 29, 2023, which is hereby incorporated herein by reference in its entirety.

### FIELD

The present invention relates to a display device with a holding device, which can be mounted on the head of a user, an image generation module, which is attached to the holding device and generates an at least two-color image, and a spectacle lens, which is attached to the holding device and images the generated at least two-color image in the head-mounted state of the holding device in such a way that the user can perceive it as a virtual image.

### BACKGROUND

Such display devices are often referred to as smart glasses, which in addition to the normal functionality of a pair of glasses have an additional light path, with which a virtual image can be reflected to the wearer of the glasses. Such display devices are intended to display a multi-color virtual image with high imaging quality and at the same time have the lowest possible weight.

### SUMMARY

An object of the invention is to further develop a display device of the type mentioned in the introductory part in such a way that the requirements mentioned in the introduction are met as well as possible.

The display device in certain embodiments comprises a holding device, which can be mounted on the head of a user, an image generation module, which is attached to the holding device and generates an at least two-color image, and a spectacle lens, which is attached to the holding device and images the generated at least two-color image in the head-mounted state of the holding device in such a way that the user can perceive it as a virtual image. The image generation module can have a first imager, which generates a first color image of the at least two-color image, and a second imager, which generates a second color partial image of the at least two-color image, and also a combiner, which comprises a first and a second entry surface, at least one first reflection layer, which reflects one of the two color partial images and transmits the other of the two color partial images, and an exit surface. The first color partial image enters the combiner via the first entry surface and is guided along a first color channel to the first reflection layer. Furthermore, the second color partial image enters the combiner via the second entry surface and is guided along a second color channel to the first reflection layer. The combiner overlays the two color partial images by means of the first reflection layer to obtain the at least two-color image, which exits via the exit surface of the combiner and is guided to the spectacle lens. The first entry surface is formed in such a way and/or a first hologram is formed in the first color channel in such a way that a first imaging function for the first color partial image is present, which serves to correct an aberration caused by the spectacle lens.

This allows the desired correction to be carried out individually or selectively in terms of color. Since the already necessary combiner is to be adapted merely by the formation of the first entry surface and/or the formation of a first hologram in the first color channel, a higher image quality can be realized without greater weight, which would be present if additional elements were to be provided.

One of the two color partial images can be reflected at the first reflection layer, whereas the other of the two color partial images can be transmitted, so that an overlay can be realized thereby to obtain the at least two-color image.

The first entry surface may be curved and/or have geometric structuring to realize the first imaging function for the first color partial image. The second entry surface may be planar and/or free of geometric structuring.

The corrected aberration can be, in particular, a longitudinal chromatic aberration and/or a lateral chromatic aberration.

The curvature of the first entry surface can be a spherical curvature, an aspherical curvature or a toric curvature. Furthermore, the first entry surface may have a curved free-form surface, which is not spherically, aspherically or torically curved. Geometric structuring may be in particular geometric structuring which leads to a diffractive grating.

Furthermore, the second entry surface may be formed and/or a second hologram may be formed in the second color channel in such a way that a second imaging function for the second color partial image is present, which serves to correct the aberration caused by the spectacle lens.

The second entry surface may be curved and/or have geometric structuring to realize the second imaging function for the second color partial image.

Furthermore, the image generation module may have a third imager, which generates a third color partial image of the at least two-color image. In this case, the at least two-color image is preferably formed as an at least three-color image. The third color partial image enters the combiner via a third entry surface and is guided along a third color channel to a second reflection layer of the combiner. The second reflection layer is reflective for a first wavelength range and transmissive for a second and a third wavelength range. In this case, the first reflection layer is preferably reflective for e.g. the second wavelength range and transmissive for the first and third wavelength ranges. The first wavelength range can be selected according to the first color partial image, the second wavelength range can be selected according to the second color partial image, and the third wavelength range can be selected according to the third color partial image. The wavelength ranges are preferably selected such that the desired overlay of the three color partial images to obtain the at least three-color image can be realized. For example, the three wavelength ranges can thus be suitably selected for a red, a green, and a blue color partial image.

The third entry surface may be formed and/or a third hologram may be formed in the third color channel in such a way that a third imaging function for the third color partial image is present, which serves to correct the aberration caused by the spectacle lens. In particular, the third entry surface may be curved and/or have geometric structuring to realize the third imaging function for the third color partial image. However, it is also possible that the third entry surface is planar and free of geometric structuring.

The curvature of the second entry surface and the curvature of the third entry surface may be formed or further developed in the same manner as the curvature of the first entry surface. Furthermore, the geometric structuring of the second entry surface and the geometric structuring of the third entry surface may be formed or further developed in the same manner as the geometric structuring of the first entry surface.

The first reflection layer may be formed as a first dichroic layer, which reflects a color partial image from the group of the first and second color partial images and transmits the other color partial image. Furthermore, the combiner may have a second dichroic layer (e.g. the second reflection layer), which reflects a color partial image from the group of the second and third color partial images and transmits a color partial image. Furthermore, the first dichroic layer can transmit or reflect the third color partial image, and the second dichroic layer can transmit or reflect the first color partial image.

In particular, the two dichroic layers can intersect at an angle of 90° and be arranged in a beam combination cube (also called X-cube). For example, a beam combination cube is a dichroic prism cube in which four rectangular prisms are joined together to form a cube in such a way that the first and second dichroic layers intersect at an angle of 90°.

The first and second dichroic layers (or also the first and second reflection layers) can also be spaced apart from each other or be parallel. In this case, the combiner can be realized as a prism rod (also called rod combiner), which has a plurality of parallelepiped prisms, which are set in succession, wherein the dichroic layers are arranged on the corresponding sides of the parallelepiped prisms. In such an arrangement, a further color for the multi-color image can be added as it were with every additional parallelepiped prism.

The beam path from the first imager to the first entry surface may be free of imaging optical elements. The same applies to the beam path from the second imager to the second entry surface and to the beam path from the third imager to the third entry surface.

However, it is also possible that at least one optically imaging element is arranged in at least one of the beam paths from the respective imager to the respective entry surface.

In addition, the exit surface of the combiner may be planar. However, it is also possible to design the exit surface of the combiner to be curved. In this case, the curved exit surface of the combiner represents an additional design degree of freedom for imaging the at least two-color image. As a result of this use of the exit surface, the requirements relating to the further optical surfaces for guiding and coupling out the at least two-color image as a virtual image subsequently relax.

The spectacle lens may comprise a front side, a rear side, an entry section and a deflection section spaced apart from the entry section, an exit section in the rear side and a light guide channel. The spectacle lens can guide the at least two-color image, which is coupled into the spectacle lens via the entry section of the spectacle lens, by at least one reflection in the spectacle lens to the deflection section, which deflects the at least two-color image toward the exit section such that the at least two-color image exits the spectacle lens via the exit section. The deflection section and the exit section can be spatially separate sections. In this case, the deflection section can deflect the at least two-color image toward the exit section, via which the at least two-color image then exits from the spectacle lens. However, it is also possible that the deflection section and the exit section coincide spatially, e.g. if the deflection section is designed as a surface grating.

The deflection section may comprise a single reflective, refractive and/or diffractive deflection element or a plurality of adjacent reflective, refractive or diffractive deflection elements. With a plurality of adjacent deflection elements, a desired deflection function and optionally an imaging function of the deflection section can be realized in a Fresnel-like manner, for example (this can of course also be realized with a single deflection element). The deflection elements may be reflective, refractive and/or diffractive surface pieces, which may also be referred to as reflective, refractive and/or diffractive facets. The reflective, refractive and/or diffractive surface pieces may be in each case planar. However, it is also possible that the reflective, refractive and/or diffractive surface pieces themselves are curved. They can, for example, be spherically or aspherically curved or be formed as a curved free-form surface. In the same way, the single reflective, refractive and/or diffractive deflection element may be planar or curved. For example, the reflectivity of the respective reflective deflection elements (or the single reflective deflection element) may be in the range of 1-100% (including the limits of the range) for the respective wavelength or color of the generated image. Thus, the reflective deflection elements can be, for example, partially reflective or reflective. In particular, the deflection element or the deflection elements may have an imaging function in addition to their function of beam deflection.

Since the coupling-out deflection section should be as invisible as possible and the light coming from the environment to the eye of the observer should also have as little negative impact as possible, deflection sections which have a high transmittance in transmitted light and associated therewith a low reflectivity for the light beams, which are to be coupled out, of the generated (preferably at least two-color) image are generally preferred. Typical values for the ratio of reflection to transmission are values of e.g. less than or equal to 50% to greater than or equal to 1% (e.g. any values from this range in 1% steps) and in particular e.g. 50%, 40%, 30%, 20%, 10%, 9%, 8%, 7%, 6%, 5%, 4%, 3%, 2% or 1%, evenly distributed over the visible length range. The entry section may in the same way as the deflection section have a single reflective, refractive and/or diffractive entry element or a plurality of adjacent reflective, refractive or diffractive entry elements. The entry element or elements can be further developed in the same way as the deflection elements. In particular, the entry element or elements can cause a beam deflection and/or have an imaging function.

The exit section may have a single reflective, refractive and/or diffractive exit element or a plurality of adjacent reflective, refractive or diffractive exit elements in the same way as the deflection section. The exit element or elements can be further developed in the same way as the deflection elements. In particular, the exit element or elements can cause a beam deflection and/or have an imaging function.

In particular, the spectacle lens may have a curved rear side and/or a curved front side. The entry section may be formed in the rear side.

The at least two-color image is preferably guided by one or more reflections (in particular total internal reflections) to the deflection section. The one or more reflections or total internal reflections can be realized, for example, at the front side and/or rear side of the spectacle lens. However, it is also possible that at least one of the reflections or the total internal reflections is realized at a layer buried in the spectacle lens, which layer is spaced apart from the front side and rear side.

The display device may have a control unit that controls the image generation module. In particular, the control unit can control the image generation module based on supplied image data.

The imagers can be designed as surface-type imagers. The respective imager may include an LCD module, LCOS module, OLED module, uLED module, or a tilt mirror matrix. Each imager can have a plurality of pixels, which can be arranged, for example, in rows and columns. For example, each imager can be self-luminous or non-self-luminous.

Each imager can preferably generate a monochromatic image, wherein different imagers generate monochromatic images with different wavelengths (and thus color partial images). At least one imager may also be designed such that it generates a multi-color image (and thus a multi-color color partial image).

The image generation module may thus comprise, for example, a combination of two or more monochromatic imagers or a combination of a duochromatic imager and a monochromatic imager.

For example, the color partial images can be a red, a green, or a blue color partial image. It is also possible to generate at least one further color partial image with a further wavelength, such as from the IR range.

It will be apparent that the features mentioned above and those still to be elucidated below are usable not just in the combinations specified but also in other combinations or on their own, without leaving the scope of the present invention.

The invention will be elucidated in greater detail hereinafter using exemplary embodiments with reference to the appended drawings, which likewise disclose features essential to the invention. These exemplary embodiments serve merely for elucidation and should not be interpreted in a restrictive manner. For example, a description of an exemplary embodiment having a multitude of elements or components should not be interpreted to mean that all these elements or components are necessary for implementation. Instead, other exemplary embodiments may also contain alternative elements and components, fewer elements or components, or additional elements or components. Elements or components from different exemplary embodiments may be combined with one another, unless stated otherwise. Modifications and variations that are described for one of the exemplary embodiments may also be applicable to other exemplary embodiments. To avoid repetition, identical or mutually corresponding elements in different figures are given the same reference signs and are not elucidated again.

### BRIEF DESCRIPTION OF THE DRAWINGS

FIG. 1 is a schematic perspective illustration of an embodiment of the display device according to certain embodiments of the invention;

FIG. 2 is an enlarged partial sectional view of the first spectacle lens including a schematic illustration of the image generation module;

FIG. 3 is an enlarged illustration of the image generation module according to a further exemplary embodiment;

FIG. 4 is an enlarged illustration of the image generation module according to a further exemplary embodiment, and

FIG. 5 is an enlarged illustration of the image generation module according to a further exemplary embodiment.

### DETAILED DESCRIPTION

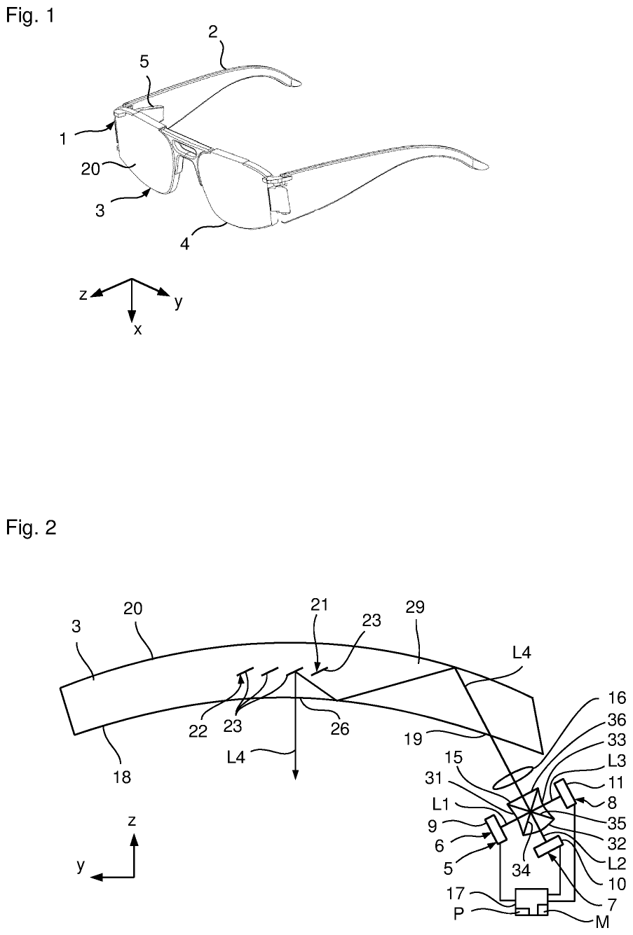

In the embodiment shown in FIG. 1, the display device 1 comprises a holding device 2, which can be mounted on the head of a user and may be designed, for example, in the manner of a conventional spectacle frame, and a first and a second spectacle lens 3, 4, which are attached to the holding device 2. The holding device 2 with the spectacle lenses 3, 4 can be designed, for example, as sports glasses, sunglasses, and/or eyeglasses for the correction of defective vision, wherein a virtual image can be superimposed into the field of view of a user via the first spectacle lens 3, which is designed as a spectacle lens according to certain embodiments and which can also be referred to as a multifunctional lens, as described below.

For this purpose, the display device 1 comprises an image generation module 5, which can be arranged in the region of the right eyeglass temple of the holding device 2, as shown schematically in FIG. 1. The image generation module 5 may comprise a first imager unit 6 for generating a red partial image, a second imager unit 7 for generating a green partial image, and a third imager unit 8 for generating a blue partial image, as shown schematically in FIG. 2. For this purpose, each of the imager units 6-8 comprises a surface-type image generation element 9, 10 and 11 respectively. Each of the surface-type image generation elements 9-11 may comprise, for example, an OLED element, an LCD element, an LCOS element, a uLED module or a tilt mirror matrix, each of which comprises a multiplicity of pixels arranged, for example, in rows and columns. As representative for the light beams emitted from the surface-type image generation elements 9-11 (and thus for the corresponding color partial image), an individual light beam L1, L2 and L3 is drawn in each case schematically.

Of course, the specific arrangement of the first imager unit 6 for generating the red partial image, the second imager unit 7 for generating the green partial image, and the third imager unit 8 for generating the blue partial image is merely an example. The three imager units 6-8 can also be swapped as desired. For example, the first and third imager units 6, 8 can be swapped.

As can be further seen in FIG. 2, the image generation module 5 further comprises an overlaying element 15 or a combiner 15 (here in the form of a beam splitter cube) and also an image module optics unit 16. The image module optics unit 16 may also be omitted or integrated in the first spectacle lens 3. Furthermore, a control unit 17 with, for example, a processor P and a memory M for controlling the image generation module 5 is provided. The control unit 17 controls, depending on the supplied image data, the image generation module 5 and in particular the image generation elements 9-11 in such a way that the color partial images generated by means of the three image generation elements 9-11 in overlay result for a viewer in a multi-color image according to the image data. For this purpose, the light beams L1 -L3 from the three surface-type image generation elements 9-11 are overlaid by means of the overlaying element 15 to form a common light beam L4, which travels through the image module optics unit 16 and enters the spectacle lens 3 via a curved rear side 18 thereof. The region of the entrance at the rear side 18 can also be referred to as entry section 19. If the image module optics unit 16 is part of the spectacle lens 3, the first surface of the image module optics unit 16, on which the light is incident, is the entry surface or the entry section 19.

The first spectacle lens 3 further comprises a curved front side 20 and a deflection section 21 buried in the first spectacle lens 3.

The deflection section 21 comprises a reflective deflection structure 22 with a plurality of reflective deflection elements 23, which can also be referred to as reflective facets.

As has already been described, the light beams L1-L3 enter the first spectacle lens 3 as a common light beam L4 via the entry section 19 in the rear side 18. The common light beam L4 is then guided in the first spectacle lens 3, for example by total internal reflection at the rear side 20 and front side 18 to the deflection section 21, so that a light guide channel 29 from the entry section 19 to the deflection section 21 is present. The deflection section 21 deflects the common light beam L4 toward the rear side 18 in such a way that the deflected common light beam L4 exits from the first spectacle lens 3 via the rear side 18. The region via which the common light beam L4 exits can also be referred to as exit section 26.

The image generation module 5 and the first spectacle lens 3 are designed such that a user wearing the display device 1 on their head can perceive the multi-color image generated by means of the image generation module 5 as a multi-color virtual image.

When guiding the common light beam L4 (and thus the color partial images) in the first spectacle lens 3, aberrations (e.g. longitudinal and/or lateral chromatic aberrations) may occur, for example, due to the input coupling via the curved entry section 19 at the curved rear side 18 and due to the total internal reflections at the curved front side 20 and the curved rear side 18, which aberrations are wavelength-dependent and therefore different for the color partial images (e.g. in terms of the actual size or the actual profile of the aberration), which can lead to undesirable image errors that the user can perceive.

In order to be able to correct these wavelength-dependent aberrations, the combiner 15 is specifically designed as described below.

The combiner 15 comprises a first, a second and a third entry surface 31, 32, 33, each of which are curved, a first and a second dichroic splitter layer 34 and 35, and an exit surface 36, wherein the red color partial image (light beam L1) enters the combiner 15 via the first entry surface 31, the green color partial image (light beam L2) enters via the second entry surface 32, and the blue color partial image (light beam L3) enters via the third entry surface 33 and they travel to the dichroic splitter layers 34 and 35. In a variant which is not shown, only one of the three entry surfaces 31-33 is curved and the two remaining entry surfaces 31-33 are planar. In a further variant that is not shown, exactly two of the three entry surfaces 31-33 are curved and the remaining entry surface 31-33 is planar.

The first dichroic splitter layer 34 reflects the red color partial image (light beam L1) and transmits the green color partial image (light beam L2) and the blue color partial image (light beam L3). The second dichroic splitter layer 34 reflects the blue color partial image (light beam L3) and transmits the red color partial image (light beam L1) and the green color partial image (light beam L2). As a result, the three color partial images (light beams L1-L3) are overlaid to obtain the multi-color image and leave the combiner 15 via the exit surface 36.

The region of the combiner 15 from the first entry surface 31 to the first dichroic splitter layer 34 can be referred to as the first color channel (here the red color channel). In the same way, the region of the combiner 15 from the second entry surface 32 to the first and second dichroic splitter layers 34 and 35 can be referred to as the second color channel (here the green color channel), and the region of the combiner 15 from the third entry surface 33 to the second dichroic splitter layer 35 can be referred to as the third color channel (here the blue color channel).

As is strongly exaggerated and schematically illustrated in FIG. 2, the first and third entry surfaces 31 and 33 are, for example, concavely curved and the second entry surface 32 is convexly curved. This is, however, merely an example. For example, all three entry surfaces can also be concavely or convexly curved. Furthermore, for example, only one or two of the three entry surfaces 31-33 may be concavely or convexly curved. An essential point in the possible curvature of at least one of the entry surfaces 31-33 is that a wavelength-dependent aberration occurring in the first spectacle lens 3 due to the light guidance can be corrected wavelength-selectively (here for the red, green and blue color partial images) with the correspondingly curved entry surface 31-33.

The curvature of the corresponding entry surface 31-33 can be spherical, aspherical or toric, for example. A curved free-form surface which has no spherical, no aspherical or no toric curvature is also possible.

With the curved entry surface(s) 31-33, chromatic aberrations can thus be corrected individually in terms of color in particular. This is particularly advantageous in connection with the first spectacle lens 3, since the first spectacle lens 3 is made (e.g. monolithically) of one material, so that it is not possible to correct chromatic aberrations by choosing achromat material combinations.

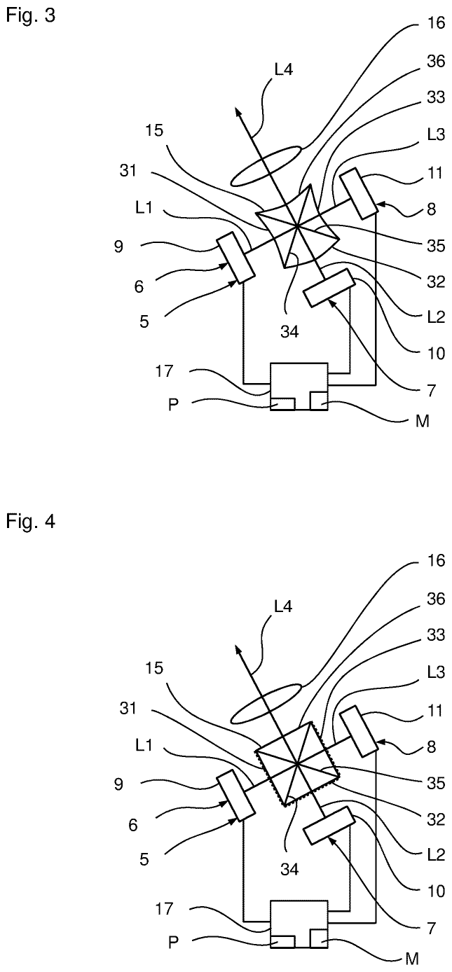

In addition, as shown in the exemplary embodiment of FIG. 3 (wherein only the image generation module 15 is shown enlarged), the exit surface 36 may be curved (in contrast to the embodiment of FIG. 2, in which the exit surface 36 is planar). The exit surface 36 represents an additional interface and thus an additional design degree of freedom for the multi-color image. By using the exit surface 36 as an interface having an imaging effect (due to the curvature of the exit surface 36), the requirements relating to the remaining optically effective surfaces of the first spectacle lens 3 are relaxed, such as the requirements relating to the deflection section 21. In the exemplary embodiment of FIG. 4, the entry surfaces 31-33 are not curved but are planar and at the same time geometrically structured to diffractively bring about an imaging function. It can also be said that the entry surfaces 31-33 each have a diffraction grating. These diffraction gratings, for example, have the same imaging optical function as the curved entry surfaces 31-33 according to FIG. 2.

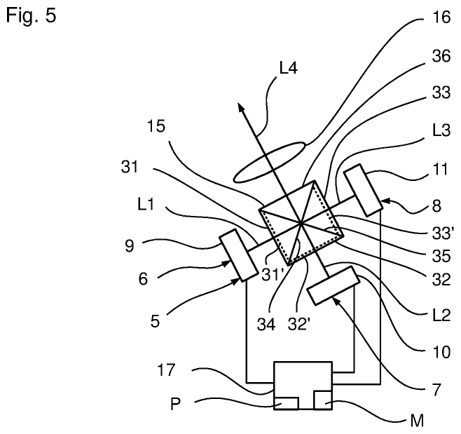

In the exemplary embodiment of FIG. 5, the entry surfaces 31-33 are not curved but are planar. In addition, holograms 31′, 32′ and 33′ are formed in the color channels, which holograms bring about the desired imaging functions for the color partial images.

Depending on the reflectivity of the deflection elements 23, the virtual image can be perceived by the user in overlay with the environment. At a very high reflectivity and in particular at a reflectivity of 100%, the user can perceive at least in the region of the deflection section 21 only the virtual image and not the environment if a specific distance of the deflection elements 23 is not exceeded. If the specific distance of the deflection elements 23 is exceeded, ambient light can reach the eye unhindered through them, so that even at 100% reflectivity of the deflection elements 23 a view through to the environment is possible, so that as it were a perforated/segmented 100% mirror is present.

The first deflection structure 22 can bring about a pure beam deflection. Preferably, it can additionally provide an imaging effect.

In the display device 1, the superposition of the virtual image into the user's field of view is realized via the first spectacle lens 3. Of course, a superposition via the second spectacle lens 4 is also possible. Furthermore, the display device 1 may be designed such that information or virtual images are reflected via both spectacle lenses 3, 4. The superposition can be carried out in such a way that a three-dimensional image impression is created. However, this is not absolutely necessary.

The spectacle lenses 3, 4 may have a refractive power of zero or a refractive power different from zero (in particular for correcting defective vision). In particular, both the front side 20 and the rear side 18 may be curved. The front side 20 is in particular spherically curved. If the spectacle lens 3, 4 has a refractive power different from zero to correct defective vision, usually the curvature of the rear side 18 is selected accordingly to achieve the corresponding correction. The rear side 18 may have a curvature deviating from the spherical shape.

1-11. (canceled)

12. A display device, comprising:
a holding device that can be mounted on the head of a user;
an image generation module, which is attached to the holding device and generates an at least two-color image; and
a spectacle lens, which is attached to the holding device and images the generated at least two-color image in the head-mounted state of the holding device such that the user can perceive the generated at least two-color image as a virtual image,
wherein the image generation module includes:
a first imager, which generates a first color partial image of the at least two-color image, and,
a second imager, which generates a second color partial image of the at least two-color image,
a combiner, comprising at least a first and a second entry surface, at least one first reflection layer, which reflects one of the two color partial images and transmits the other of the two color partial images, and an exit surface,
wherein the first color partial image enters the combiner via the first entry surface and is guided along a first color channel to the first reflection layer,
wherein the second color partial image enters the combiner via the second entry surface and is guided along a second color channel to the first reflection layer,
wherein the combiner overlays the two color partial images via the first reflection layer to obtain the at least two-color image, which exits via the exit surface of the combiner and is guided to the spectacle lens,
wherein the first entry surface is formed and/or a first hologram is formed in the first color channel such that a first imaging function for the first color partial image is present, which serves to correct an aberration caused by the spectacle lens.

13. The display device of claim 12, wherein the first entry surface is curved and/or has geometric structuring to realize the first imaging function for the first color partial image.

14. The display device of claim 12, wherein the second entry surface is formed and/or a second hologram is formed in the second color channel such that a second imaging function for the second color partial image is present, which serves to correct the aberration caused by the spectacle lens.

15. The display device of claim 14, wherein the second entry surface is curved and/or has geometric structuring to realize the second imaging function for the second color partial image.

16. The display device of claim 12, wherein the combiner has a second reflection layer, which is reflective for a first wavelength range and transmissive for a second wavelength range.

17. The display device of claim 16, wherein the two reflection layers intersect at an angle of 90°and are arranged in a beam combination cube.

18. The display device of claim 12, wherein the beam path from the first imager to the first entry surface is free of imaging optical elements.

19. The display device of claim 12, wherein the exit surface of the combiner is curved.

20. The display device of claim 12,
wherein the spectacle lens has a front side and a rear side, an entry section and a deflection section spaced apart from the entry section, an exit section in the rear side, and
wherein the spectacle lens comprises a light guide channel, which guides the at least two-color image, which is coupled into the spectacle lens via the entry section of the spectacle lens, by at least one reflection in the spectacle lens to the deflection section, by which the at least two-color image is deflected, to exit from the spectacle lens via the exit section.

21. The display device of claim 20, wherein the deflection section comprises a plurality of adjacent reflective, refractive and/or diffractive deflection elements.

22. The display device of claim 12, wherein the aberration caused by the spectacle lens is a longitudinal chromatic aberration and/or a lateral chromatic aberration.
